(19) United States
(12) Patent Application Publication
(10) Pub. No.: US 2024/0403794 A1
(43) Pub. Date: Dec. 5, 2024

(54) CENTRALIZED SOURCE PLATFORM FOR PERFORMANCE BENEFITS

(71) Applicant: Accenture Global Solutions Limited, Dublin (IE)

(72) Inventors: Ellyn Jo Shook, New York, NY (US); Rajendra Prasad Tanniru, Bangalore (IN); Sangeetha Jayaram, Mumbai (IN); Colin Anderson, Chicago, IL (US); Gayathri Pallail, Bangalore (IN); Sangeeta S. Iyer, Bangalore/Karnataka (IN); Briana Claire Mendonca, Sterling, VA (US); Ilhan Scheer, Heidelberg (DE); Easwer Chinnadurai, Lutz, FL (US); Santosh Sundaresan, Chennai (IN); Ruchi Marwaha, Bangalore, Karnataka (IN)

(21) Appl. No.: 18/675,772

(22) Filed: May 28, 2024

(30) Foreign Application Priority Data
May 29, 2023 (IN) 202311036943

(51) Int. Cl. G06Q 10/0639; G06N 20/00

(52) U.S. Cl. CPC G06Q 10/06398; G06N 20/00

(57) ABSTRACT

Methods, systems, and computer-readable storage media for forecasting an engagement index score. A trained machine learning model is executed to forecast a set of engagement index score for a respective set of entities based on provided data for the set of entities. The data includes performance properties of each entity of the set. In response to the executing the trained machine learning model, a set of influencing factors is determined based on the engagement index scores of the set of entities. Actions are identified to be performed in association with the set of entities based on the identified influencing factors. The actions are provided for display at a display of a device.

### CLAIM OF PRIORITY

This application claims priority to Indian application No. 202311036943 filed on May 29, 2023, the entire contents of which are hereby incorporated by reference in the entirety for all purposes.

### TECHNICAL FIELD

The present disclosure relates to computer-implemented methods, software, and systems for data processing and searching.

### BACKGROUND

Customers' needs are transforming and imposing higher requirements for process execution. Artificial intelligence (AI) finds implementations in different use cases in the context of data processing. Machine learning (ML) models may be trained to allow interactions with user computers using natural language.

### SUMMARY

Implementations of the present disclosure are generally directed to computer-implemented systems for data processing and prediction service.

In some implementations, a solution is provided that serves as a centralized source of information for employees (entities) defined for an organization. The information can relate to entity's experience aspects or track record related to their performance recorded in organizational systems.

Implementations of the present disclosure relate to systems and methods for determining actions to be performed in association with a set of entities based on identified influencing factors according to an execution of a trained language model. The proposed systems and methods leverage a trained ML model to identify the influencing factors for a set of entities so to determine actions to be performed based on these identified influencing factors. Since the ML model is trained on de-biased data and predictions are made while considering potential bias in the input data for executing the ML model, the ML model can accurately identify trends in provided data for entities. Based on the identified trends (or data patterns), relevant influencing factors that contribute to the observed trends can be identified.

In a first aspect, this document describes a method including: executing a trained ML model to forecast a set of engagement index score for a respective set of entities based on provided data for the set of entities, wherein the data includes performance properties of each entity of the set; in response to the executing the trained ML model, determining a set of influencing factors based on the engagement index scores of the set of entities; identifying actions to be performed in association with the set of entities based on the identified influencing factors; and providing the actions for display at a display of a device.

In some implementations, the ML model can be trained based on training data that is balanced in representation of performance properties for entities of the organization. Initial entity data can be obtained and processed by performing data augmentation and de-biasing to provide a refined set of data for the entities to be used for generating the training data.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 is a flow diagram that presents an example method for identifying actions to be performed for entities based on determined influencing factors according to an executed trained ML model in accordance with implementations of the present disclosure.

FIG. 3 is a block diagram that presents an example of a system environment of a centralized source platform that obtains data from various data sources and provides the data for training a ML model in accordance with implementations of the present disclosure.

FIG. 4 is a block diagram of an example of a system including components for data processing to identify influencing factors and visualize an action plan in accordance with implementations of the present disclosure.

FIG. 5 represents a set of index diagrams, where the x-axis is a time axis, and y-axis is time series data output showing engagement index.

FIG. 6 presents source code that can be used to implement an algorithm to analyze trends in data to predict future values in a time series model.

FIG. 7 presents a diagram including prediction values based on source data and using exponential smoothing prediction techniques.

FIG. 8 presents source code that can be used to implement an algorithm for training data to forecast engagement index of employees.

FIG. 9 presents a diagram showing an example SHAP value defining the impact on the model output.

FIG. 10 presents source code that can be used to implement density-based clustering and self-organizing maps algorithms.

### DETAILED DESCRIPTION

Implementations of the present disclosure are generally directed to computer-implemented systems for processing data from various sources to provide insight into employee engagement and experience by identifying influencing factors according to a trained ML model.

Assessing the current level of engagement/belongingness is crucial for an organization. However, measuring engagement in an organization can dependent on multiple factors such as: physical wellbeing, emotional wellbeing, financial wellbeing, etc. Also, entity's levels of engagement (e.g., employee engagement) can change over time due to various factors such as work environment, leadership, and culture. At present, there is a lack of automated tools or systems that can accurately obtain quantifiable data for entities, remove biases in the data and measure an employee's engagement index in a holistic manner. Entity engagement can be determined when evaluating data associated with different factors such as:
1. Financial Factors
2. Physical Wellbeing
3. Emotional Wellbeing
4. Connectedness
5. Career

In accordance with the present implementation, an engagement index can be generated that considers data associated with the above identified factors to determine one or more influencing factors that can be used to determine actions to be performed within systems associated with the organization. In some implementations, the actions can be defined for changes to defined process flows to be executed for employees or other flows configured at systems of the organization, for example, for distributing work and assigning tasks.

In some implementations, a platform can be defined to serve as a centralized source of information related to entities such as employees. The platform can obtain data related to performance of entities at the organization, for example, related to entities' career properties (career level), wellbeing (e.g., as quantified based on execution of surveys or evaluations), etc. The platform can consolidate data from different sources, geographies, data that is of different type or format, and can use the data to provide intelligent insights for the entities. For example, the insight can be identification of influencing factors relevant for the entities in the organization for which the data is obtained. In some implementations, an ML model can be trained based on training data obtained through such a centralized platform so that the ML model can forecast engagement index scores for entities, determine influencing factors for the entities, and identify actions to be performed based on the determined influencing factors.

In some implementations, there can be multiple roles defined for the platform that may be associated with different tasks and access rights to process data obtained for entities. It is noted that any data collected for entities is data for which consent is obtained. Further, the collected data is stored, maintained and processed according to consented rules. For example, such roles can include: employee, human resources (HR) representatives, Project Leads, Managers (e.g., HR Solution Manager, other.

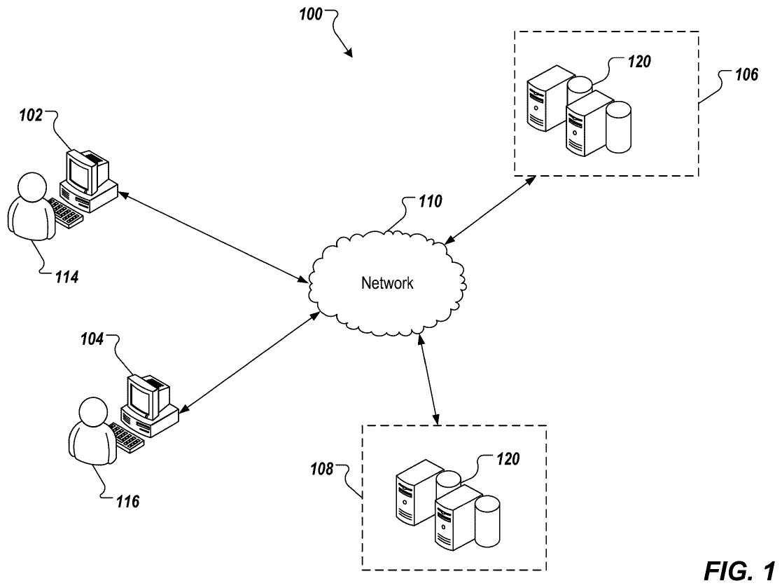

FIG. 1 depicts an example environment 100 that can be used to execute implementations of the present disclosure. In some examples, the example environment 100 can be an environment where a platform solution is implemented and executed to provide services and access to data to a set of users, for example, employees of an entity configured with accounts for the platform solution. The example environment 100 includes computing devices 102, 104, back-end systems 106, 108, a network 110. In some examples, the computing devices 102, 104 are used by respective users 114, 116 to log into and interact with the platforms and running applications according to implementations of the present disclosure.

In the depicted example, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing devices 102, 104), and back-end systems (e.g., the back-end systems 106, 108). In some examples, the network 110 can be accessed over a wired and/or a wireless communications link. For example, mobile computing devices, such as smartphones can utilize a cellular network to access the network 110.

In the depicted example, the back-end systems 106 and 108 each include at least one server system 120. In some examples, the at least one server system 120 hosts one or more computer-implemented services that users can interact with using computing devices. For example, components of enterprise systems and applications can be hosted on one or more of the back-end systems 106, 108. In some examples, a back-end system can be provided as an on premise system that is operated by an enterprise or a third party taking part in cross-platform interactions and data management. In some examples, a back-end system can be provided as an off-premise system (e.g., cloud or on-demand) that is operated by an enterprise or a third-party on behalf of an enterprise.

In some examples, the computing devices 102, 104 each include a computer-executable applications executed thereon. In some examples, the computing devices 102, 104 each include a web browser application executed thereon, which can be used to display one or more web pages of platform running application. In some examples, each of the computing devices 102, 104 can display one or more GUIs that enable the respective users 114, 116 to interact with the computing platform.

In accordance with implementations of the present disclosure, and as noted above, the back-end systems 106, 108 may host enterprise applications or systems that require data sharing and data privacy. In some examples, the client device 102 and/or the client device 104 can communicate with the back-end systems 106 and 108 over the network 110.

In some implementations, at least one of the back-end servers 106 and/or 108 can be a cloud environment that includes at least one server and at least one data store 120. In the example of FIG. 1, the back-end server 106 can be a cloud environment that is intended to represent various forms of servers including, but not limited to, a web server, an application server, a proxy server, a network server, and/or a server pool. In general, server systems accept requests for application services and provide such services to any number of client devices (for example, the client device 102 over the network 110).

In some implementations, the embodiments of the present disclosure can be implemented at a back-end server such as one of the back-end servers 106 and/or 108, where for example, it can be executed as a cloud solution that can be accessed based on requests from users, for example, associated with a computing device, such as the computing devices 102 and/or 104.

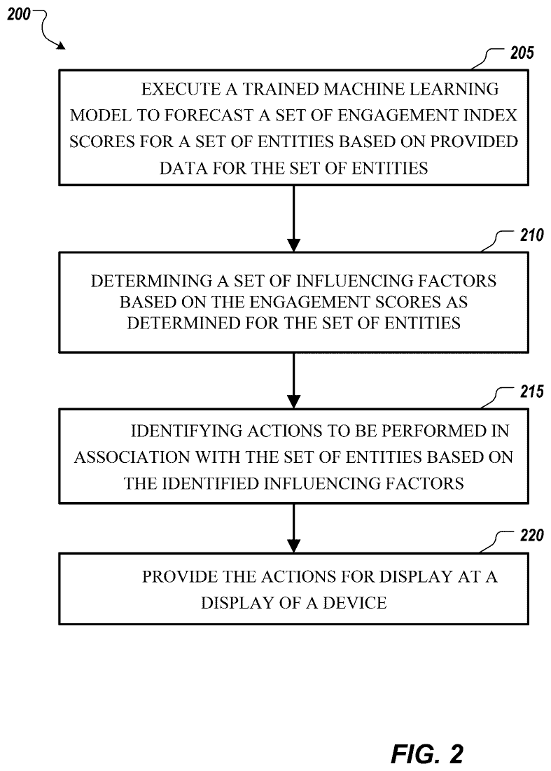

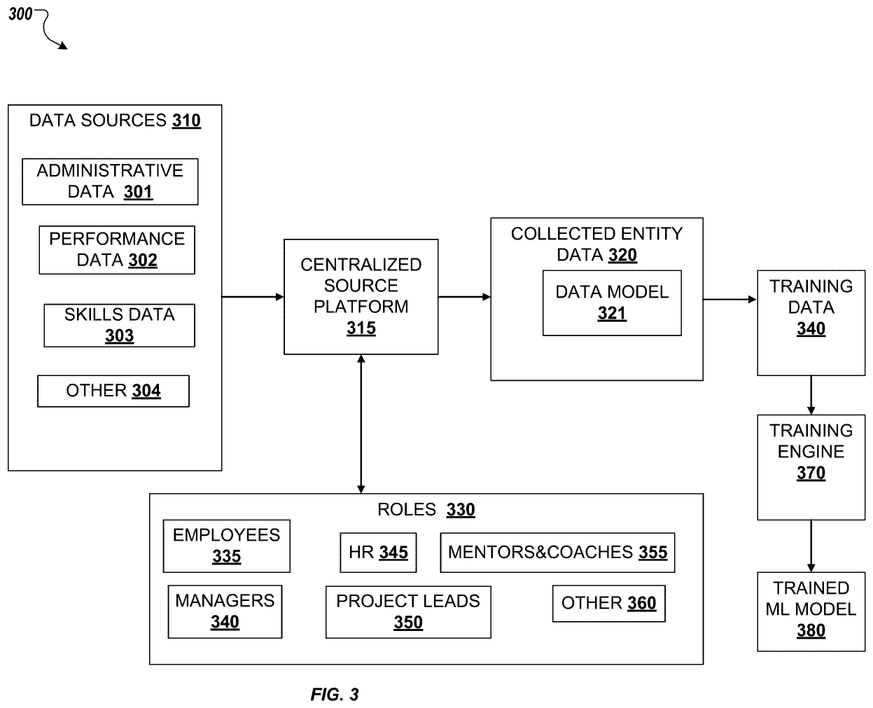

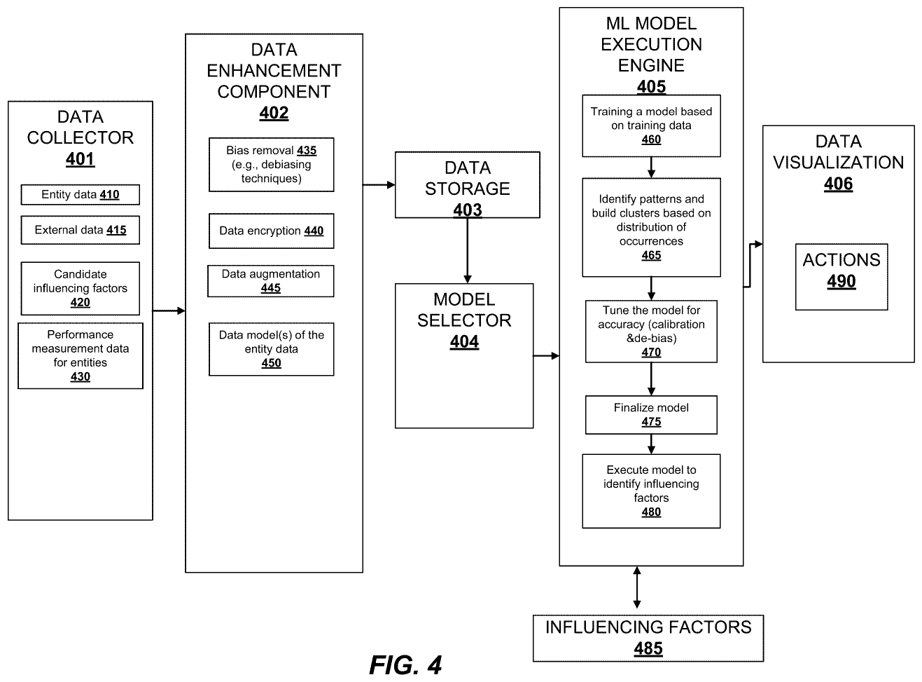

FIG. 2 is a flow diagram that presents an example method 200 for identifying actions to be performed for entities based on determined influencing factors according to an executed trained ML model in accordance with implementations of the present disclosure. In some implementations, the method 200 can be executed within a system environment as described in relation to FIG. 3. In some implementations, the method 200 for providing actions based on identified influencing factors can be triggered based on an initiation event (e.g., received request for a set of entities) or based on a scheduled schema for triggering the identification of influencing factors for the set of entities, for example, once every month, on the first Monday every month, or other triggering rule. Different operations of the method 200 can be performed by components of a system, for example, an engine for executing a trained ML model, such as the component 405 for ML model execution as described in relation to FIG. 4.

At 205, a trained ML model is executed to forecast a set of engagement index score for a respective set of entities based on provided data for the set of entities. The data obtained for the set of entities can be data obtained from a data storage that consolidates data for the set of entities from various data sources as described in relation to FIGS. 3 and 4. The data for the set of entities include performance properties of each entity of the set. The performance properties can be defined at a data model for storing data for the entities, for example, such as the data model 321. The data model can include data associated with different aspects of the entity at the organization, such as employee career level, mid-year performance evaluation score for the entity, received recognition, awards, promotions, etc. These different aspects of the performance of an entity that are defined in the data model can correspond to parameters defined at the ML model to determine engagement scores.

Data obtained for entities to forecast the engagement index score can include performance properties data. The performance properties of an entity can be defined as parameters for the ML model that is trained and used to identify influencing factors. The influencing factors can be considered as those parameters of the ML model (corresponding to performance properties of entities) that are of highest relevance for an entity. The determination of the parameter of the highest entity can be determined according to the trained rule of the ML model.

For example, the engagement score can be determined by the ML model as a function of parameters (performance metrics that are evaluated to determine those that are influencing the engagement score calculation) including:
Employee Career Level.
Mid-Year Feedback
Final Year Feedback
Surveys output
Talent Outcome
Tenure of Resource at a level
Absenteeism Rate
Last Promotion & date
Training & Development Participation
Employee Engagement Surveys
Market Trends
Workload
Working hours
Recognition and Rewards
Team Dynamics
Health and Well-being
Organizational Support
Empowerment and Autonomy
Inclusion and Diversity
Work Environment/Location

The ML model can evaluate a set of entities based on obtained data for the set and identify one or more influencing factors for each of the entities. In some cases, two entities may be evaluated to have the same engagement score however that score may be associated with different influencing factors and thus different actions to be performed can be provided.

In response to the executing the trained ML model, at 210, a set of influencing factors based on the engagement index scores of the set of entities is determined.

At 215, actions to be performed in association with the set of entities based on the identified influencing factors are identified.

At 220, the actions are provided for display at a display of a device.

FIG. 3 is a block diagram that presents an example of a system environment 300 of a centralized source platform that obtains data from various data sources and provides the data for training an ML model in accordance with implementations of the present disclosure.

A centralized source platform 315 can be configured to gather data from various data sources 310 for entities defined for an organization. The data can be obtained from the data sources 310 and the data may not include a distinct identifier (or if included can be removed to impersonalize the data). The obtained data at the centralized source platform 315 can be automatically cleansed and transformed or augmented. In some implementations, the centralized source platform 315 can be configured with the data sources 310 based on relevant data to be obtained for entities of the organization and to be used for training and executing an ML model that can forecast engagement index scores as described throughout the present disclosure. For example, the method 200 of FIG. 2 can be executed through the centralized source platform 315.

The data sources 310 can include data collected from multiple geographical locations which may include biases and personally identifiable information (PI). The centralized source platform 315 can implement processes for cleansing and refining of obtained data as discussed throughout the present disclosure and for example, in the description of FIG. 4.

### Use Cases

ML models can be trained and executed on large cleansed, refined, de-biased data sets to provide engagement index scores that can help in understanding a status of an entity in an organization. The status may be determined according to rules that quantify a performance and engagement of an entity within an organization according to a predefined scale. The ML model can be trained to allocate influencing factors associated with a provided score, where the influencing factors can be used to provide actions such as recommendations for a tailor-made action plan to be applied to one or more entities associated with the organization so as to improve the engagement index score of the entity. The engagement index scores of a group of entities (e.g., a team of employees part of a project, department, task execution, or other defined granularity) can be also considered in combination to determine actions to be performed with regard to multiple entities, or with regard to multiple processes that are associated with at least some of the entities in the group.

In some implementations, the centralized source platform 315 can obtain data for entities in an organization from different source, where the data is associated with parameters of a model for forecasting engagement scores for the entities. The centralized source platform 315 can obtain data from data sources 310, understand different roles 330 of entities associated with an organization, and generate collected entity data 320 according to a data model 321. The centralized source platform 315 can be associated with various systems related to the organization(s) of entities and can be provided with data for the roles 330 defined for the entities. For example, the roles 330 associated with entities include employee 335, human resource representative 345, mentors and coaches 355, managers 340, project leads 350, and other 360. The roles 330 as defined can be provided with data associated with tasks and authorizations relevant for the respective roles. Further, the roles 330 can be provided with mapping to particular processes configured for executed in relation to the organization, for example, configured at one or more systems of the organization.

The data model 321 can define a structure for consolidating data from various sources and defining records per entity which includes data from various sources. The collected entity data 320 can be processed according to techniques such as de-biasing techniques and data augmentation to generate training data 340. The training data 340 can be provided to a training engine 370 to train an ML model and generate the trained ML model 380.

In some implementations, an ML model can be defined to calculate an engagement index score as a function of parameters including at least some of the below listed parameters:
Employee Career Level
Mid-Year Feedback
Final Year Feedback
Surveys output
Talent Outcome
Tenure of Resource at a level
Absenteeism Rate
Last Promotion & date
Training & Development Participation
Employee Engagement Surveys
Market Trends
Workload
Working hours
Recognition and Rewards
Team Dynamics
Health and Well-being
Organizational Support
Empowerment and Autonomy
Inclusion and Diversity
Work Environment/Location

In some implementations, the centralized source platform 315 can collect data from the data sources 310 and organize the data into records according to the data model 321. The data model 321 can be defined with consideration to the parameters relevant for the ML model to compute engagement index scores for entities.

In some implementations, the centralized source platform 315 can be configured to dynamically obtain new data from the defined data sources 310 and populate the data into the collected entity data 320. When the trained ML model 380 is invoked for execution for a set of entities, the data for the set of entities can be obtained from the collected entity data 320 as current data relevant for the entities and used for the trained ML model execution to forecast engagement index scores for the set of entities.

The data sources 310 can include administrative data 301 that can include information such as position of the entity, team or department, role, etc. The data sources 310 can also include performance data 302 that can include data for a performance level allocated to an entity, or can include text description of the performance. The data sources 310 can also include sources providing skills data 303 that map a skill set to an entity or other data 304. The skill set data can be associated with entity's experience, education, qualifications, other. The data sources 310 can include other data that can be needed by the centralized source platform 315 for training an ML model to forecast engagement index scores for entities.

In some implementations, the parameters for the calculation of the engagement index score can be defined to include data according to a data model or schema. For example, data associated with a parameter “final year feedback” can be a value defined according to a scale of 0 to 10 to quantify the feedback obtained for the entity. For other parameters, different models or rules may apply and data may be provided in various formats and style. The data can include text and/or numerical data. In some implementations, a record for a given entity can include values for each of the parameters. The values can be obtained from different data sources of the data sources 310 and consolidated according to the data model 321 as collected in the collected entity data 320.

In some implementations, AI Powered Content Extractors can be defined at the centralized source platform 315 that can efficiently retrieve data from the data sources 310 for entities having one or more of the roles 330. The AI powered content extractors can be implemented as AI-based language models (LLMs) that can automatically access and retrieve entity information and provide it for the collected entity data 320 generation.

In some implementations, an LLM-based ChatBot can be defined as human centric Chatbot bot that can rely on LLM models trained based on data obtained from one or more of the data sources 310 to retrieve information about entities that is associated with particular topics that can be domain-specific to one or more entities, groups of entities (e.g., associated with a geographical location), defined projects, or the organization. The LLM-based ChatBot can provide a user interface to engage with end users who provide requests for data and provide accurate responses based on obtained data by the centralized source platform 315. In some implementations, the LLM-base ChatBot can rely on output provided by the trained ML model 380.

In some implementations, the centralized source platform 315 can include the collected entity data 320 as stored within the platform, together with the training data 340 and the trained ML model 380. The training engine 370 may be instantiated on the centralized source platform 315 or can be running as an external engine provided with the training data 340. In some implementations, the centralized source platform 315 can be a cloud platform or an on-premises platform and can run over multiple data sources distributed over different locations.

In some implementations, the centralized source platform 315 can provide a user interface to receive request that can be as text messages or voice messages that request data associated with entities of the organization associated with the centralized source platform 315. For example, the user interface can include a request to trigger the execution of the method as described in relation to FIG. 2.

In some implementations, when the trained ML model 380 is invoked for a set of entities, relevant data for the entities can be obtained, for example, from the collected entity data 320 and an engagement index score can be determined. The engagement index score can be evaluated to determine influencing factors on the entities to provide recommended actions or an action plan to be executed for one or more of the entities of the set.

In some implementations, centralized source platform supports an automated approach that allows for a comprehensive understanding of entities performance within the organization. For example, it can provide an understanding of the needs, preferences, and challenges of employees in an organization. In some cases, the needs, preferences, and challenges can be associated with executed processed at the organization. For example, input related to the employees needs, preferences, and challenges can be used to define instructions related to configurations of process's execution.

For example, by using advanced algorithms and ML techniques, personalized and curated plans to enhance engagement index scores of employees across an organization can be provided. These plans may include targeted training programs, career development opportunities, flexible work arrangements, recognition initiatives, and tailored communication strategies. By proactively addressing specific areas for improvement and aligning them with employee preferences, organizations can foster an engaged and motivated workforce, leading to higher overall organization-wide engagement levels.

In some implementations, when the training data 340 is generated, considerations for identifying and mitigation hidden bias can be made so that different data augmentation techniques can be performed to modify the collected entity data 320 to remove bias and thus when used for training the ML model 380 to provide a more accurate model that is de-biased compared to other models that can rely on biased data. The generation of the training data 340 can be performed as described in relation to FIG. 4, and for example, by a data enhancement component 402 of FIG. 4.

In some implementations, a key challenge in consolidating data can be associated with missing data across system of records. With data coming through different system and according to different data schemas, some data for entities may be missing. Data augmentation can be performed to address such issues by performing custom-built data imputation and data synthesis. For example, statistical methods can be used to first identify and classify the missing data (as below) before deciding how to best handle it. For example, missing data can be classified into one of the following: Missing Completely at Random (MCAR), Missing at Random (MAR), and Not Missing at Random (NMAR). MCAR data is missing completely independently of any other data, MAR data is missing due to some other factor in the data set, and NMAR data is missing due to the absence of some feature of interest. Depending on the amount of data and the implications of the missing data, strategies such as imputation, data organization, de-identification, or data exclusion are used.

In some implementations, the data obtained from the data sources 310 can include multilingual data. In such instances, a proprietary API can be provided at the centralized source platform 315 to translate data incoming from one or more data sources into a common language that can be used for the collected entity data 320. For example, a machine translation can be used to generate an understanding of the data in multiple languages. Additionally, Natural Language Processing/Understanding (NLP/NLU) techniques are be used to identify understand the semantics on common ground.

In some implementations, data biases and data ethical considerations can be associated with the relied upon data. For example, given the diverse nature of entities across geographies, a current market available model may require modifications to address multiple bias and ethical considerations. First data governance practices are utilized to help identify hidden biases in data sets and mitigate their effects. In some implementations, techniques such as sampling biases, data augmentation, model calibration, and predictive analytics can be applied to handle biases. In some implementations, creating a workflow pipeline that uses the combination of above-mentioned data manipulation techniques, that includes identifying inconsistencies in the data, leveraging NLP to correctly parse unstructured data, and using data normalization techniques to standardize the data. Additionally, automated validation checks are be used to ensure high quality of data used for pattern recognition and insights.

FIG. 4 is a block diagram of an example of a system 400 including components for data processing to identify influencing factors and visualize an action plan in accordance with implementations of the present disclosure.

In some implementations, the system 400 can be implemented to train an ML model that can identify influencing factors on engagement of entities within an organization and provide actions based on calculated engagement scores that can improve the engagement of entities.

In some implementations, the implementation of training and executing the ML model can be substantially similar to the discussed techniques in relation to FIG. 3. In some implementations, a data collector 401 can be configured to collect data for entities from various data sources, for example, such as the data source 310 of FIG. 3. The data collector 401 can collect data such as entity data 410 (for example, from administrative data sources 301 of FIG. 3), external data 415 (e.g., data acquired for external public data providers such as research institutions or agencies), candidate influencing factors 420 (e.g., data obtained from human resource systems identifying factors that affect the engagement of employees such as social benefits, salary, working days, etc.), and performance measurement data for entities 430 (e.g., such as the performance data 302 of FIG. 3). The data collection can be performed based on obtained and confirmed consent from the data providers for the manner of storing and maintaining the data, as well as the data's scope of use.

In some implementations, collected data at the data collector 410 can be provided to a data enhancement component 402 to enhance the data by identifying and mitigating hidden bias existing in the obtained data so that training data that is de-biased can be used for training the ML model thus to ensure accurate and relevant forecasting results for the engagement scores of entities.

For example, the data collector 410 can collect data across multiple systems for employees of an organization. Such data can be refined at the data enhancement component 402. The entity data 410 part of the collected data can include data such as employee profile data including:
Employee Name
Employee Career Level
Mid-Year Feedback
Final Year Feedback
Surveys output
Talent Outcome
Tenure of Resource at a level
Absenteeism Rate
Last Promotion & date
Training & Development Participation
Employee Engagement Surveys
Market Trends
Workload
Working hours
Talent Outcome
Surveys output
Employee Engagement Surveys

Such data may be associated with possibilities for bias, for example, in relation to data such as talent outcome data or employee engagement surveys data.

The data collected by the data collector 401 can include market trends data as part of external data 415 that can be collected from external public data sources.

In some implementations, the data enhancement component 402 implements techniques associated with:
Bias removal 435 through debiasing techniques such as sampling Bias. To identify sampling bias, obtained data can be evaluated to determine whether it includes a balances representation of occurrences of data of different populations. For example, whether the sample that is obtained includes entities with different performance levels that are presented with a number of occurrences that accurately represents the entities in the organization (the entire population). Techniques such as stratified sampling or oversampling underrepresented groups can be used to mitigate bias. For example, if certain career levels or demographic groups are underrepresented in the data, oversampling those groups can help balance the dataset.
Data encryption 440 can be performed to compress and reduce the size of the data and to efficiently transfer it between different component and utilize distributed parallel processing to handle large volumes of data.
Data Augmentation 445 can be used to generate additional data and diversify the dataset. For example, if there's bias towards positive appraisal feedback, synthetic data points representing negative feedback can be generated to balance the distribution and balance the distribution of occurrence. Data enhancement techniques can be implemented to populate missing data based on statistical analysis of existing data to provide an estimation for the missing data.
Data model of the entity data 450 can be defined and re-fined to collect relevant data for the entities that can be used for training the ML model.

In some instances, if based on evaluating distribution of occurrences in the data provided for training the ML model it is determined that inherent bias is present in performance measurement data for a first performance measurement attribute (performance metric or a parameter of the ML model), artificial data can be generated to be added to the initial data to generate the training data. The artificial data includes instances that include occurrences of values for the first performance measurement attribute that were underrepresented in the initial data.

For example, the data provided below in Example 1 can be example data obtained for employee engagement modelling. The data in Example 1 includes bias since it includes a disproportionate number of positive appraisal feedback for employees at higher career levels compared to those at lower levels.

Original Data (Before De-Biasing):

Career Level: Senior, Appraisal Feedback: Positive
Career Level: Junior, Appraisal Feedback: Positive
Career Level: Senior, Appraisal Feedback: Positive
Career Level: Junior, Appraisal Feedback: Negative

### Example 1

After applying debiasing techniques as described in the present application, the data can be enhanced to be as provided in Example 2 below.

De-Biased Data (After De-Biasing):

Career Level: Senior, Appraisal Feedback: Positive
Career Level: Junior, Appraisal Feedback: Positive
Career Level: Senior, Appraisal Feedback: Negative
Career Level: Junior, Appraisal Feedback: Negative

### Example 2

In the above example, applying the debiasing technique adjusts the data in Example 1 to ensure a more balanced representation of appraisal feedback across different career levels, that when used for training the ML model results in a more accurate employee engagement model that can be used to determine relevant influencing factors to the employees.

In some implementations, the data enhancement component 402 can output enhanced data that is de-biased and augmented to be stored at a data storage 403. For example, the data storage 403 can be a dedicated storage space for storing data for the organization. In some implementations, the data storage 403 can be provided by a centralized source platform such as the centralized source platform 315 of FIG. 3.

A model selector 404 can be provided to obtain data from the data storage 403 and select an ML model to be trained based on the obtained data. The selected model is provided to a ML model execution engine 405 that is configured to train models, at 460, based on obtained training data. The obtained training data is data that is enhanced based on the techniques implemented at the data enhancement component 402. The trained model can include defined parameters as previously discussed for which data is collected from the data collector 401.

At 465, patterns in the training data can be identified and clusters of data can be built based on the distribution of the occurrences of values per parameters of the trained model.

At 470, the model is tuned for accuracy by implementing calibration and de-biasing techniques that support improved accuracy of the prediction of the engagement scores. Calibration techniques can be used to adjust the model's predictions to align with ground truth outcomes and reduce bias. Such calibration techniques can involve comparing predicted probabilities to observed outcomes and performing adjustments to the model as necessary. For example, if the model consistently underestimates engagement for certain groups, calibration techniques can correct for this bias by adjusting the model for these groups. The model can be finalized at 475 and used for running over input data associated with one or more entities of an organization. The execution of the model can be based on obtained data for the entities, such as the data obtained through the data collector 401 and as discussed in relation to FIGS. 2 and 3.

In some instances, when training the machine learning model to forecast engagement index scores, the trained model can be tested to determine the model's accuracy. In some instances, test data for testing the trained model can be obtained. The test data can include i) prediction data and ii) observed data. The prediction data can be data obtained based on ML model executions where the execution output includes predictions for engagement index scores for the entities. The observed data is obtained based on provided observed engagement index scores for the entities after from actions determined based on the predictions are performed for the entities. The testing data can be provided to perform calibration of the machine learning model to adjust the forecasting of the ML model based on differences between at least a portion of data in the predicted data and the observed data.

In some implementations, after training the model, predictions can be made on new data while considering potential biases. De-biasing techniques, such as re-weighing or adversarial training, can be applied during prediction to mitigate bias. For example, re-weighing techniques can be applied to adjust contribution of at least some data point based on their proximity to a boundary point, thus, to effectively reduce the influence of biased data points.

In some implementations, executing the ML model to forecast the set of engagement index score for the set of entities based on the data provided for the set of entities comprises: defining weights for contribution of the parameters to be used for the execution, wherein a weight adjusts a contribution of a parameter when evaluated by the ML model. The weights assigned to different influencing factors as parameters of the ML model can vary based on at least one of organizational priorities, the specific goals, and/or individual employee needs. For example, job role and performance history may be weighted more heavily when providing recommendation for actions to improve engagement results influences by career development opportunities, while work-life balance and health factors may be prioritized for recommendations of actions related to employee well-being initiatives.

In some implementations, if data provided for executing the ML model is determined to be biased since there is disproportionality between occurrences of data for entities of a given group (or cluster), weights assigned to parameters of the ML model can be adjusted to account for such identified bias in the provided data for the ML model execution. In accordance with implementations of the present disclosure, by considering a combination of influencing factors on entity level, adjusting weights as needed based on identified bias in provided data for executing the ML model, a centralized source platform that runs the ML model or another system that is configured to execute the ML model can generate tailored-made action plans that are both personalized and equitable for all employees.

In some implementations, when the trained model is executed, influencing factors for an entity can be determined at 480. For example, for each entity for which the ML model is executed, a set of influencing factors 485 can be output as aspects to analyze and determine further actions. In some implementations, the influencing factors 485 that are determined for a given entity can be a set of a list of influencing factors considered by the ML model as parameters for the model. In some examples, based on a calculated engagement score, it is possible to determine that talent outcome is an influencing factor for the engagement score of the entity, and a set of actions can be determined to be applied to improve the engagement score, where the actions are associated with the talent outcome. In some instance, association techniques can be applied that rely on actions that are available to be performed for entities that are determined to be influences by a given influence factor so that their engagement score, when recomputed after the actions are implemented can be modified to show improved engagement compared to the initially computed engagement score. In some implementations, when determining actions to be performed, the actions can be selected based on considering available actions to be performed as associated with the respective influencing factor and individual unique data obtained for the entities from the data used to run the model.

In some implementations, multiple influencing factors can be analyzed and one or more actions can be provided as a recommendation. The determined actions can be relevant for the entity that is evaluated or for other entities within the organization. For example, an influencing factor for the engagement of an employee can be the number of working hours. For such an influencing factors, actions can be defined for the employee and the respective manager of the employee. In another example, if training and development is determined as the influencing factor, actions for the employee can be determined that are relevant for that factor, where these actions may or may not overlap with the actions associated with another influencing factor. In some implementations, influencing factors can be determined for groups of entities, for example, entities associated with a given geographical location, part of a particular department, working on project of a given topic, other criteria.

In some implementations, based on executing the model at 480 and determining the influencing factors 485, actions 490 as determined based on the influencing factors 485 can be provided for display at a data visualization 406 component. The actions 490 can be provided in different format and can be associated with triggers for initiation of processes defined at systems of the organization, e.g., including the employee in new projects, assigning new tasks in systems, enrolling for execution of new trainings, other.

In some implementations, data collected at the data collected 401 can be used to iteratively retrain the model to accurately predict engagement scores.

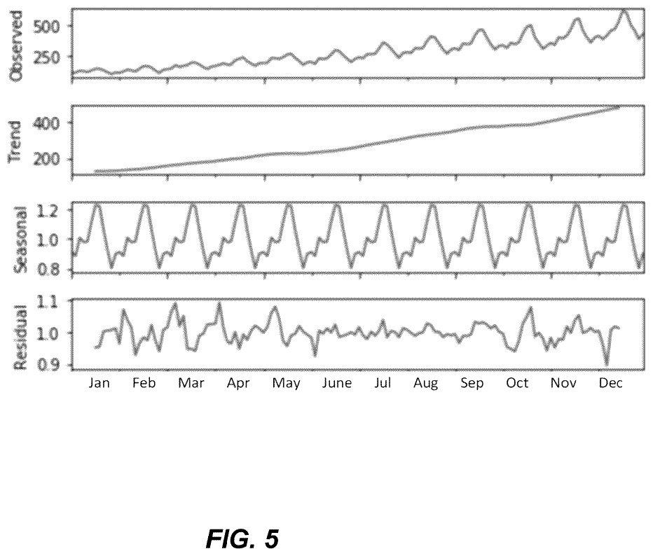

FIG. 5 represents a set of index diagrams, where the x-axis is a time axis, and y-axis is time series data output showing engagement index.

In some implementations, an algorithm to analyze trends in data to perform predictions can include the following steps presented in a pseudo code at Table 1.

TABLE 1

| | |
|---|---|
| 1. | Import Arima libraries for time series modeling. |
| 2. | Load the historical data on employee engagement. |
| 3. | Convert the data into a time series format, with Months as the index and engagement |
| | values as the columns. |
| 4. | Visualize the time series data using Matplotlib to identify any trends or seasonality. |
| 5. | Use time series decomposition techniques - additive models to separate the trend, |
| | seasonality of the time series data. |
| 6. | Split the data into training and testing sets. |
| 7. | Testing Sets were created using 80 / 20 rule. |
| 8. | Use time series model (ARIMA) on the training data and tune the hyperparameters to |
| | improve the model's performance. |
| 9. | Use the fitted model to make predictions on the testing data and evaluate the model's |
| | accuracy using metrics such as Mean Absolute Error (MAE) or Root Mean Squared Error |
| | (RMSE). |
| 10. | Once the model is validated, use it to predict the engagement values month on month |
| | for a year. |
| 11. | Visualize the predicted values using Matplotlib to identify any trends or patterns in the |
| | predicted data. |
| 12. | If there is a section “Know your employees' engagement” where the above insights |
| | and prediction visualizations are displayed, such section can be enabled only for Leadership |
| | and HR Leads. |

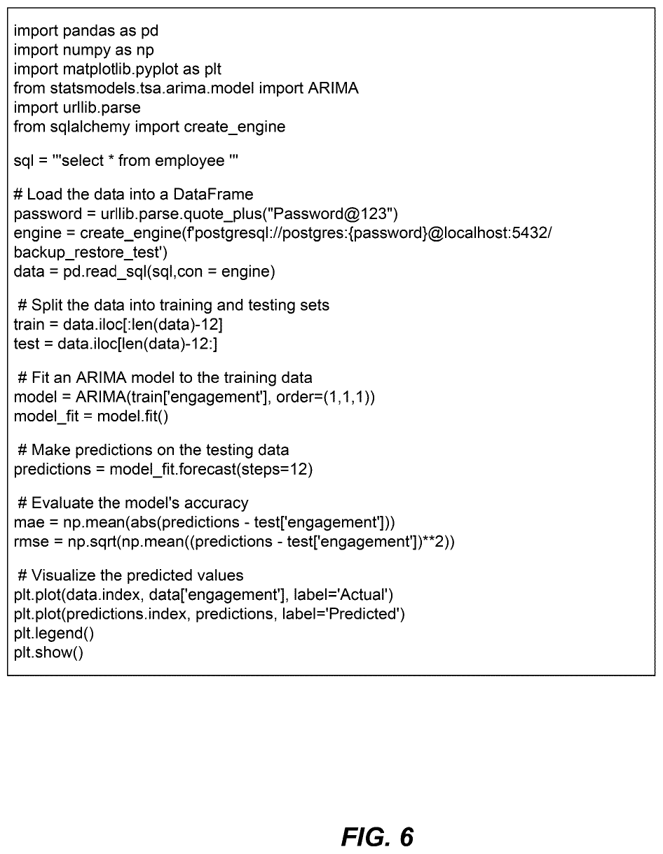

FIG. 6 presents source code that can be used to implement an algorithm to analyze trends in data to predict future values in a time series model.

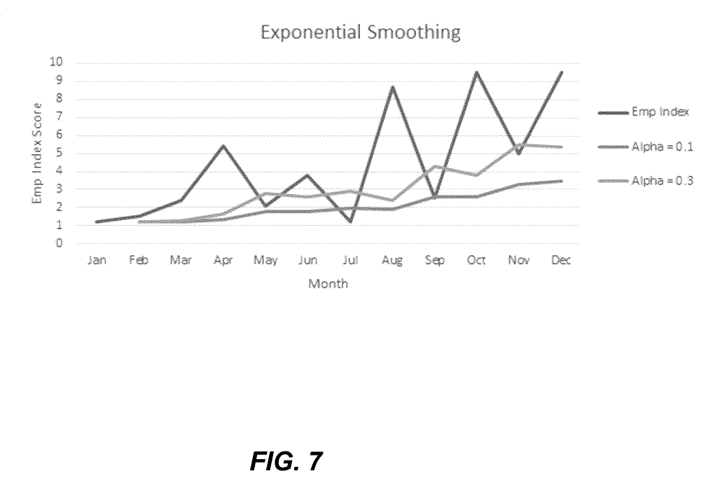

FIG. 7 presents a diagram including prediction values based on source data and using exponential smoothing prediction techniques.

The exponential smoothing can be performed by calculating a weighted average of the previous ‘N’ Employee Engagement values, where the weights of each value decrease exponentially over time. By doing this, we take into account the trend of the data as well as any local changes, allowing for accurate predictions even with limited data.

In some examples, the exponential smoothing can be performed according to an algorithm including the steps as presented at Table 2.

TABLE 2

| | |
|---|---|
| 1. | Initialize a weight array with length equal to the number of |
| | months the emp-index data points are available. |
| 2. | Calculate the exponentially decreasing weights for each |
| | point in the data set. |
| 3. | Loop through the data array and calculate the weighted average |
| | of the previous k data points. |
| 4. | Repeat Step 3 until all data points have been processed. |
| 5. | Output the predicted values. |

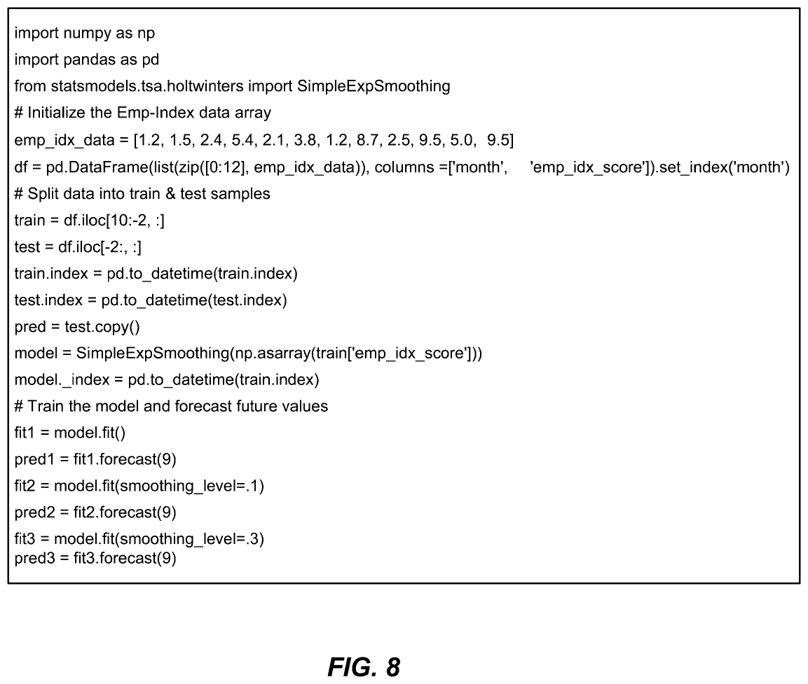

FIG. 8 presents source code that can be used to implement the algorithm as presented at Table 2.

In some implementations, a decision tree model can be then used. The Decision Trees can help in determining the Individual's Engagement Index and top reasons for Engagement Index score are obtained by looking at the feature importance scores of the random-forest model. The SHAP values provide great insights into the models' decision-making process showing details into how each feature impacts the engagement index.

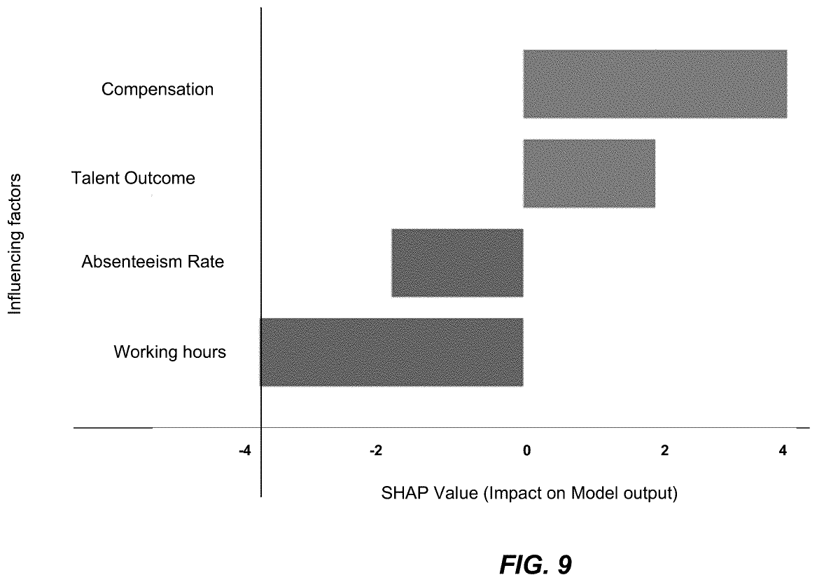

FIG. 9 presents a diagram showing an example SHAP value defining the impact on the model output.

In some implementations, a decision tree model can be used to find out the resources that have higher or lower engagement index. Variables contributing to low engagement of the employees were identified. The key ones were:
1. Working hours
2. Compensation
3. Talent Outcome
4. Learning hours (self) and employees at same level
5. Surveys—Connectedness & belongingness with team (Group level survey level results applied to all employees within that group)

Employees at risk for low engagement were tagged with one of the above reasons. Recommended Action plans were created based on organization Policies.

Table 3 below includes the steps of a decision tree model to determine engagement indexes for resources that are related to the engagement of employees

TABLE 3

| | |
|---|---|
| 1. | Import scikit-learn libraries for building decision tree models. |
| 2. | Load the historical data on resources into a Pandas DataFrame (data loaded - job role, |
| | tenure, performance ratings, salary, etc.) and the target variable (i.e., engagement). |
| 3. | Preprocess the data by handling missing values, encoding categorical variables, and |
| | scaling numerical features. |
| 4. | Split the data into training and testing sets. |
| 5. | Instantiate a decision tree model with suitable hyperparameters (maximum depth, |
| | minimum samples per leaf). |
| 6. | Fit the model to the training data. |
| 7. | Evaluate the model's performance using metrics - accuracy, precision, recall, and F1 |
| | score on the testing data. |
| 8. | Visualize the decision tree using Graphviz to interpret the model's decision-making process. |
| 9. | Use the trained model to predict the probability of engagement for each resource in the |
| | dataset. |

Table 4 below includes example source code that can be used to implement the decision tree model as described in relation to FIG. 9 and Table 3.

TABLE 4
import pandas as pd
import numpy as np
from sklearn.tree import DecisionTreeClassifier
from sklearn.model_selection import train_test_split
from sklearn.metrics import accuracy_score, precision_score, recall_score, f1_score
from sklearn.preprocessing import LabelEncoder, StandardScaler
import graphviz
sql = ‘“select*from ‘Engagement_classification’”
# Load the data into a DataFrame
password = urllib.parse.quote_plus(″Password@123″)
engine =
create_engine(f′postgresql://postgres:{password}@localhost:5432/backup_restore_test′)
data = pd.read_sql(sql,con = engine)
# Preprocess the data
data.fillna(0, inplace=True) # Handle missing values
le = LabelEncoder( )
data[′job_role′] = le.fit_transform(data[′job_role′]) # Encode categorical variables
scaler = StandardScaler( )
data[[′tenure′, ′salary′]] = scaler.fit_transform(data[′tenure′, ′salary′]]) # Scale numerical
features
# Split the data into training and testing sets
X_train, X_test, y_train, y_test = train_test_split(data.drop(′engagement′, axis=1),
data[′engagement′], test_size=0.2)
# Instantiate a decision tree model
model = DecisionTreeClassifier(max_depth=3, min_samples_leaf=10)
# Fit the model to the training data
model.fit(X_train, y_train)
# Evaluate the model's performance on the testing data
y_pred = model.predict(X_test)
accuracy = accuracy_score(y_test, y_pred)
precision = precision_score(y_test, y_pred)
recall = recall_score(y_test, y_pred)
f1 = f1_score(y_test, y_pred)
# Visualize the decision tree
dot_data = export_graphviz(model, out_file=None,
feature_names=X_train.columns,
class_names=[′No′, ′Yes′],
filled=True, rounded=True,
special_characters=True)
graph = graphviz.Source(dot_data)
graph.render(′decision_tree′)
# Predict the probability of engagement for each resource in the dataset
proba = model.predict_proba(data.drop(′engagement′, axis=1))[:,1]
# Identify resources with a high probability of engagement
threshold = 0.5
high_risk = data[proba > threshold][′employee_id′]
response = requests.post(email_url, headers=headers, data=json.dumps(email_data))

In some implementations, density-based clustering and self-organizing maps algorithms can be applied on the various employee data collected to identify common cluster groups. This helped identify common problems within certain region, location, skills, account.

In some implementations, density-based clustering and self-organizing maps algorithms can be implemented according to operations as presented in Table 5 below.

TABLE 5

| | |
|---|---|
| 1. | Initialize an empty list to store the clusters (Working |
| | hours, Performance rating, Level Of the Employee, |
| | Geographic Region, Skills). |
| 2. | Data Clusters with above categories were formed. |
| 3. | For each data point, calculate the reachability distance |
| | from its neighbors. |
| 4. | If the reachability distance of a point is lower than a certain |
| | threshold, assign it to a cluster and add it to the list. |
| 5. | Repeat Step 2 and Step 3 until all points |
| | have been assigned to clusters. |
| 6. | Return the list of clusters and the data points associated |

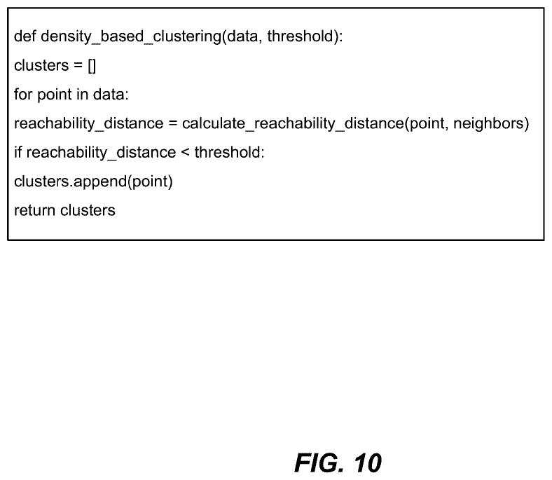

In some implementations, the algorithm as described at Table 5 can be implemented with the code as presented at FIG. 10.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the to be filed claims.

What is claimed is:

1. A computer-implemented method comprising:
executing a trained machine learning model to forecast a set of engagement index scores for a respective set of entities based on provided data for the set of entities, wherein the data includes performance properties of each entity of the set;
in response to the executing the trained machine learning model, determining a set of influencing factors based on the set of engagement index scores of the set of entities;
identifying actions to be performed in association with the set of entities based on the identified influencing factors; and
providing the actions for display at a display of a device.

2. The method of claim 1, comprising:
training, using training data, the machine learning model to forecast a first engagement index score of a first entity from entities defined at an organization, wherein the training data is balanced in representation of performance properties of the entities;

3. The method of claim 2, wherein training the machine learning model comprises generating the training data comprising:
obtaining, at a centralized source location, initial data for the entities, wherein the initial data is obtained from a plurality of data sources and for one or more performance properties of the entities, wherein the one or more performance properties are used for defining parameters of the machine learning model; and
processing the data by performing data augmentation and de-biasing to provide a refined set of data for the entities to be used for generating the training data.

4. The method of claim 1, wherein an engagement index score is determined as a function of the performance properties of the set of entities defined as the parameters of the machine learning model to identify the set of influencing factors as parameters of highest relevance based on predefined criteria.

5. The method of claim 4, wherein executing the machine learning model to forecast the set of engagement index score for the set of entities based on the data provided for the set of entities comprises:
defining weights for contribution of the parameters to be used for the execution, wherein a weight adjusts a contribution of a parameter when evaluated by the machine learning model.

6. The method of claim 2, wherein generating the training data comprises:
performing data synchronization to integrate a plurality of data sets from a plurality of data sources, wherein each set of the plurality of data sets is related to a respective set of entities from the entities, where the sets of entities associated with the plurality of data sources are overlapping.

7. The method of claim 2, wherein generating the training data comprises:
obtaining initial data for the entities from a set of data sources;
identifying sampling bias for a category of a characteristic of the entities at the initial data, wherein the sampling bias is identified by determining a distribution of occurrences of categories of respective characteristics of entities within the initial data; and
in response to the identified sampling bias, performing data imputation to generate additional data to balance representation of characteristics that were underrepresented in the initial data.

8. The method of claim 2, wherein generating the training data comprises:
obtaining initial data for the entities from a set of data sources, wherein the initial data includes data values for performance measurement attributes defined for the entities in the initial data;
evaluating distribution of occurrences in the initial data to determine inherent bias in performance measurement data for a first performance measurement attribute; and
generating artificial data to be added to the initial data to generate the training data, wherein the artificial data includes instances that include occurrences of values for the first performance measurement attribute that were underrepresented in the initial data.

9. The method of claim 2, wherein generating the training data comprises processing initially obtained data from a plurality of data sources, where the processing comprises:
transforming the initially obtained data to unify the initially obtained data based on a selected common language determined for the set of data sources, wherein the transformation comprises identifying languages associated with the data obtained from the plurality of data sources; and
performing translation of at least a portion of the data to the common language, where the common language is selected from the identified languages.

10. The method of claim 2, wherein training the machine learning model to forecast the engagement index scores comprises:
obtaining test data including i) prediction data and ii) observed data, wherein the prediction data is obtained to include predictions for engagement index scores for the entities from executions of the machine learning model, and wherein the observed data is obtained based on provided observed engagement index scores for the entities after from actions determined based on the predictions are performed for the entities; and
calibrating the machine learning model to adjust the forecasting of the machine learning model based on differences between at least a portion of data in the predicted data and the observed data.

11. A system comprising
a computing device; and
a computer-readable storage device coupled to the computing device and having instructions stored thereon which, when executed by the computing device, cause the computing device to perform operations comprising:
executing a trained machine learning model to forecast a set of engagement index scores for a respective set of entities based on provided data for the set of entities, wherein the data includes performance properties of each entity of the set;
in response to the executing the trained machine learning model, determining a set of influencing factors based on the set of engagement index scores of the set of entities;
identifying actions to be performed in association with the set of entities based on the identified influencing factors; and
providing the actions for display at a display of a device.

12. The system of claim 11, wherein the operations further comprise:
training, using training data, the machine learning model to forecast a first engagement index score of a first entity from entities defined at an organization, wherein the training data is balanced in representation of performance properties of the entities;

13. The system of claim 12, wherein training the machine learning model comprises generating the training data comprising:
obtaining, at a centralized source location, initial data for the entities, wherein the initial data is obtained from a plurality of data sources and for one or more performance properties of the entities, wherein the one or more performance properties are used for defining parameters of the machine learning model; and
processing the data by performing data augmentation and de-biasing to provide a refined set of data for the entities to be used for generating the training data.

14. The system of claim 11, wherein an engagement index score is determined as a function of the performance properties of the set of entities defined as parameters of the machine learning model to identify the set of influencing factors as parameters of highest relevance based on predefined criteria.

15. The system of claim 14, wherein executing the machine learning model to forecast the set of engagement index score for the set of entities based on the data provided for the set of entities comprises:
defining weights for contribution of the parameters to be used for the execution, wherein a weight adjusts a contribution of a parameter when evaluated by the machine learning model.

16. A non-transitory, computer-readable medium coupled to one or more processors and having instructions stored thereon which, when executed by the one or more processors, cause the one or more processors to perform operations comprising:
executing a trained machine learning model to forecast a set of engagement index scores for a respective set of entities based on provided data for the set of entities, wherein the data includes performance properties of each entity of the set;
in response to the executing the trained machine learning model, determining a set of influencing factors based on the set of engagement index scores of the set of entities;
identifying actions to be performed in association with the set of entities based on the identified influencing factors; and
providing the actions for display at a display of a device.

17. The non-transitory, computer-readable medium of claim 16, further comprising instructions, which when executed by the one or more processors, cause the one or more processors to perform operations comprising:
training, using training data, the machine learning model to forecast a first engagement index score of a first entity from entities defined at an organization, wherein the training data is balanced in representation of performance properties of the entities;

18. The non-transitory, computer-readable medium of claim 17, wherein training the machine learning model comprises generating the training data comprising:
obtaining, at a centralized source location, initial data for the entities, wherein the initial data is obtained from a plurality of data sources and for one or more performance properties of the entities, wherein the one or more performance properties are used for defining parameters of the machine learning model; and
processing the data by performing data augmentation and de-biasing to provide a refined set of data for the entities to be used for generating the training data.

19. The non-transitory, computer-readable medium of claim 16, wherein an engagement index score is determined as a function of the performance properties of the set of entities defined as parameters of the machine learning model to identify the set of influencing factors as parameters of highest relevance based on predefined criteria.

20. The non-transitory, computer-readable medium of claim 19, wherein executing the machine learning model to forecast the set of engagement index score for the set of entities based on the data provided for the set of entities comprises:
defining weights for contribution of the parameters to be used for the execution, wherein a weight adjusts a contribution of a parameter when evaluated by the machine learning model.
